(19) United States
(12) Patent Application Publication
(10) Pub. No.: US 2013/0076144 A1
(43) Pub. Date: Mar. 28, 2013

(54) SYSTEM AND METHOD FOR LIMITING PHOTOVOLTAIC STRING VOLTAGE

(71) Applicants: Mohammed Agamy, Niskayuna, NY (US); Ahmed Elasser, Latham, NY (US); Anthony William Galbraith, Wirtz, VA (US); Maja Harfman-Todorovic, Niskayuna, NY (US)

(72) Inventors: Mohammed Agamy, Niskayuna, NY (US); Ahmed Elasser, Latham, NY (US); Anthony William Galbraith, Wirtz, VA (US); Maja Harfman-Todorovic, Niskayuna, NY (US)

(73) Assignee: GENERAL ELECTRIC COMPANY, Schenectady, NY (US)

(21) Appl. No.: 13/246,934

(22) Filed: Sep. 28, 2011

(51) Int. Cl. H02J 1/00

(52) U.S. Cl. 307/77

(57) ABSTRACT

A system and method are provided for enabling a PV inverter to be connected to a string of series connected PV modules without exposing the inverter to elevated voltage stresses. The input voltage to the inverter is gradually built up by sequentially switching in more series PV modules. This system and method are simple to implement in both centralized and distributed PV power plants and in either case, it significantly increases the utilization of the PV inverter. The input switching elements can be implemented using a wide variety of parts including electro-mechanical switches, semiconductor switches (IGBTs, MOSFETs . . . , etc.) as well as MEMS devices depending on the current level and target cost. A mix of switches can also be used to assist in minimizing impedance of the final switching stage that remains connected during normal operation.

### STATEMENT REGARDING FEDERALLY SPONSORED RESEARCH & DEVELOPMENT

This invention was made with U.S. Department of Energy support under contract number DE-EE0000572. The Government has certain rights in the invention.

### BACKGROUND

The subject matter of this disclosure relates generally to photovoltaic (PV) inverters, and more particularly, to a system and method for enabling a PV inverter to be connected to a string of series connected PV modules without exposing the inverter to elevated voltage stresses.

The normal operating voltage of a PV module at maximum power point is approximately 0.6-0.8 times its open circuit voltage. A PV inverter however, has to be over designed to handle the full open circuit voltage at open circuit condition during startup. The maximum cold temperature open circuit voltage of a PV module string therefore, is designed such that it is well below the switch rating.

Previous work in this field accomplishes the voltage limitation of the PV module string by means of short circuiting the PV modules (strings) bringing the voltage down to zero, and then gradually drawing power from the modules and increasing the voltage to the maximum power operating point.

In view of the foregoing, there is a need for a system and method of enabling a PV inverter to be connected to strings with many more series connected modules, without exposing the PV inverter to the elevated voltage stresses. The system and method should be suitable for use with centralized as well as distributed PV architectures.

### BRIEF DESCRIPTION

According to one embodiment, an apparatus comprises:

a plurality of photovoltaic (PV) module stages, each PV module stage comprising an output, each PV module stage comprising a plurality of PV modules connected together in series, the plurality of PV module stages connected together to form at least one string of series connected PV module stages;

a sequentially operating switching mechanism; and

an inverter comprising an input, wherein the switching mechanism sequentially couples a plurality of PV module stage outputs to the inverter input.

According to another embodiment, a method of connecting photovoltaic (PV) modules to an inverter comprises:

providing a plurality of photovoltaic (PV) module stages, each PV module stage comprising a plurality of PV modules connected together in series, the plurality of PV module stages connected together to form at least one string of series connected PV module stages;

connecting an inverter to a power grid and charging a corresponding dc-link voltage to a predetermined value to establish a power grid current;

connecting one or more first PV module stages selected from the plurality of PV module stages directly to the inverter and regulating the output voltage of the directly connected first PV module stages to a maximum power point level;

connecting one or more additional PV module stages selected from the plurality of PV module stages directly to the inverter while the first PV module stages are directly connected to the inverter;

removing the direct connection of the first PV module stages to the inverter subsequent to connecting the one or more additional PV module stages to the inverter, such that both the first PV module stages and the one or more additional PV module stages are connected to the inverter via the one or more additional PV module stages, and regulating the combined output voltage of the connected first PV module stages and the one or more additional PV module stages to the maximum power point level.

According to yet another embodiment, a method of connecting photovoltaic (PV) modules to an inverter comprises:

providing a plurality of photovoltaic (PV) module stages, each PV module stage comprising a plurality of PV modules connected together in series, the plurality of PV module stages connected together to form at least one string of series connected PV module stages;

connecting an inverter to a power grid and charging a corresponding dc-link voltage to a predetermined value to establish a power grid current;

connecting one or more first PV module stages selected from the plurality of PV module stages directly to the inverter and regulating the output voltage of the directly connected first PV module stages to a maximum power point level;

disconnecting the one or more first PV module stages from the inverter;

connecting one or more additional PV module stages selected from the plurality of PV module stages directly to the inverter subsequent to disconnecting the one or more first PV module stages from the inverter such that both the one or more first PV module stages and the one or more additional PV module stages are connected to the inverter via the one or more additional PV module stages, and

regulating the combined output voltage of the connected one or more first PV module stages and the one or more additional PV module stages to the maximum power point level.

According to still another embodiment, a method of connecting photovoltaic (PV) modules to an inverter or dc-dc converter comprises:

providing a plurality of photovoltaic (PV) module stages, each PV module stage comprising a plurality of PV modules connected together in series, the plurality of PV module stages connected together to form at least one string of series connected PV module stages;

connecting an inverter or dc-dc converter to a power grid and charging a corresponding dc-link voltage to a predetermined value to establish a power grid current;

short circuiting the output of all but one PV module stage within a string of series connected module stages such that only the output of the single PV module stage without a shorted output is connected directly to the inverter or dc-dc converter and regulating the output voltage of the directly connected PV module stage to a maximum power point level;

subsequent to regulating the output voltage of the directly connected PV module stage to a maximum power point level, removing in succession, the short circuit across the output of each PV module stage within the string of series connected module stages having a short circuited output;

connecting in succession, the outputs of the PV module stages without shorted outputs together in series as the PV module stages without shorted outputs become available;

connecting to the inverter or dc-dc converter in succession, the output of the series connected PV module stages without shorted outputs as they become available; and

regulating in succession, the combined output voltage of the series connected PV module stages without shorted outputs to the maximum power point level as they become available.

### DRAWINGS

These and other features, aspects, and advantages of the present invention will become better understood when the following detailed description is read with reference to the accompanying drawing, wherein:

FIG. 1 illustrates a sequentially switched PV string according to one embodiment;

FIG. 2 illustrates a switching sequence for the PV strings depicted in FIG. 1 according to one embodiment;

FIG. 3 illustrates a sequentially switched PV string according to another embodiment;

FIG. 4 illustrates a switching sequence for the PV strings depicted in FIG. 2 according to one embodiment;

FIG. 5 illustrates a mechanical switching structure suitable for sequentially switching the PV strings depicted in FIGS. 1 and 3 according to one embodiment;

FIG. 6 illustrates a gate turn-off (GTO) thyristor switching structure suitable for sequentially switching the PV strings depicted in FIGS. 1 and 3 according to one embodiment;

FIG. 7 illustrates an insulated gate bipolar transistor (IGBT) switching structure suitable for sequentially switching the PV strings depicted in FIGS. 1 and 3 according to one embodiment;

FIG. 8 illustrates a MOSFET switching structure suitable for sequentially switching the PV strings depicted in FIGS. 1 and 3 according to one embodiment;

FIG. 9 illustrates a simulated sequentially switched PV string according to one embodiment;

FIG. 10 illustrates switch timing for the switches depicted in FIG. 9 according to one embodiment;

FIG. 11 illustrates current and voltage waveforms for the sequentially switched PV string illustrated in FIG. 9 according to one embodiment;

FIG. 12 illustrates a sequentially switched PV string using string inverters according to one embodiment;

FIG. 13 illustrates a sequentially switched PV string using string dc-dc converters with a central inverter according to one embodiment;

FIG. 14 illustrates a sequentially switched PV string using a multi-string or central inverter according to one embodiment;

FIG. 15 illustrates a sequentially switched PV string according to still another embodiment;

FIG. 16 illustrates a sequentially switched PV string using a string or multi-string PV inverter according to another embodiment; and

FIG. 17 illustrates a sequentially switched string or multi-string dc-dc converter according to another embodiment.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

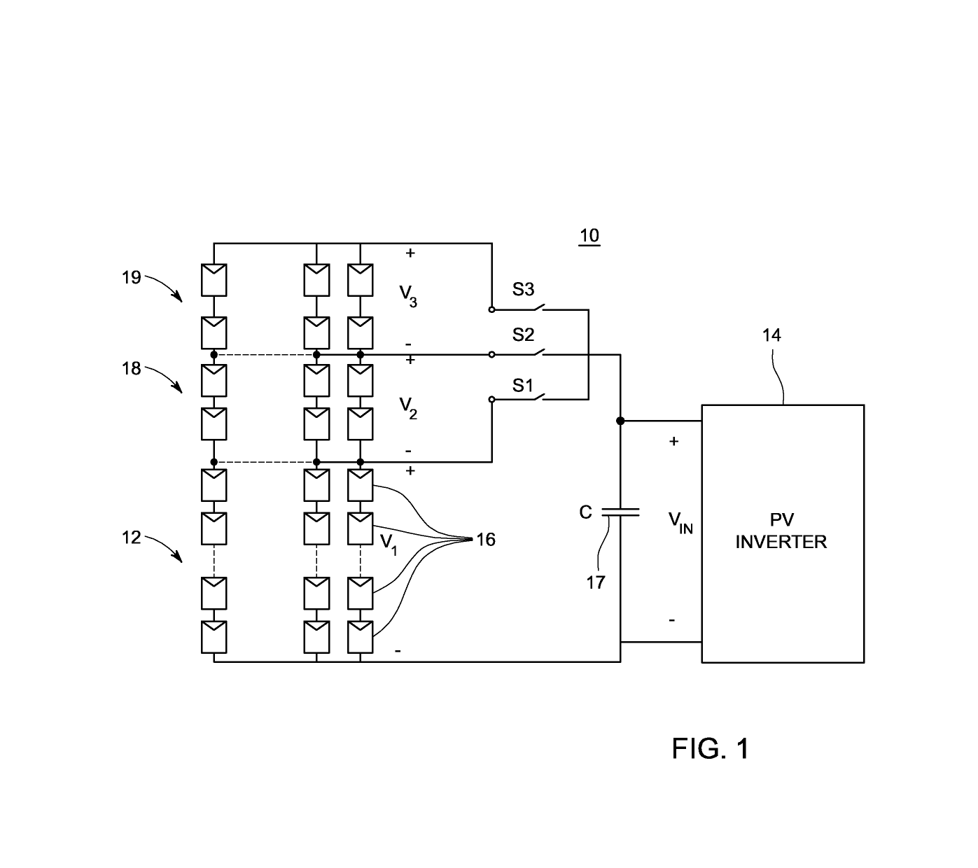

The voltage limiting embodiments described herein gradually switch in sections of PV string(s) building up an input voltage to a corresponding inverter or dc-dc converter to the maximum power point voltage level. FIG. 1 illustrates a sequentially switched PV string 10 according to one embodiment that is suitable to achieve the desired switching and gradual build-up of a PV inverter 14 input voltage level.

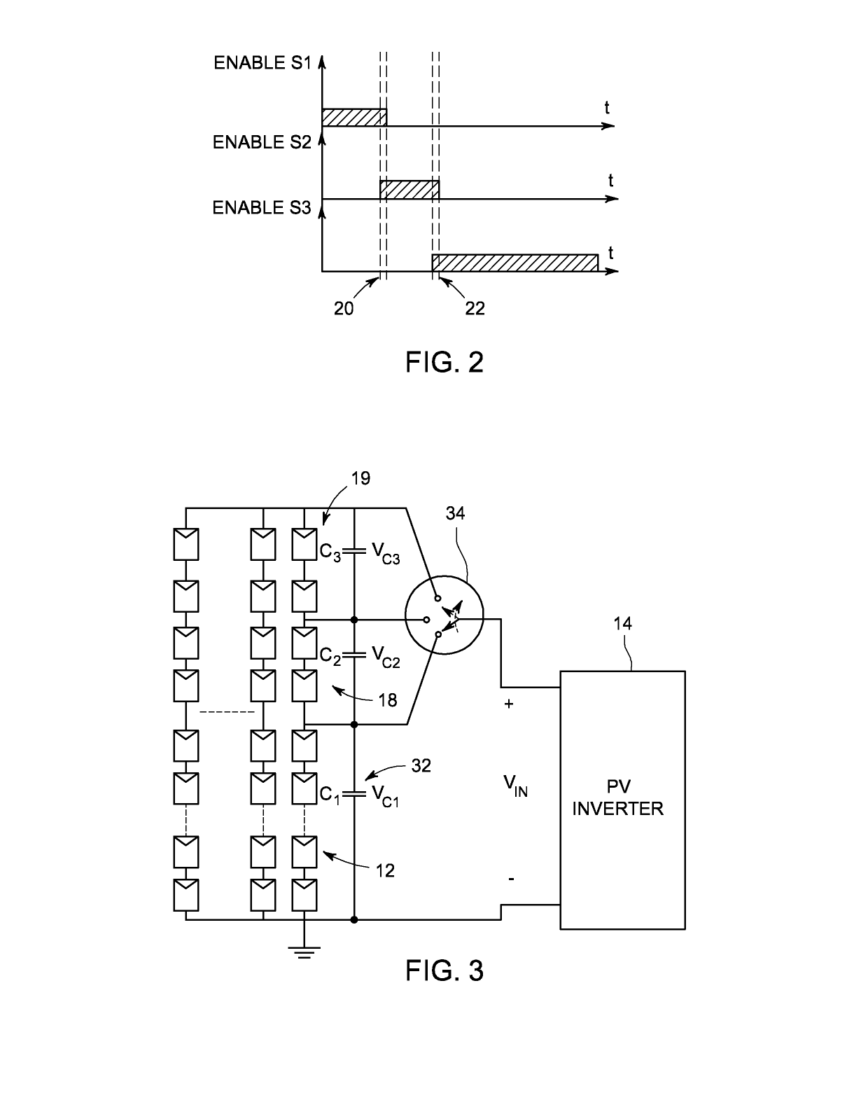

During startup, switch 51 is first enabled, connecting the lowermost stage 12 of the PV string 10 to the PV inverter 14, so the PV inverter 14 sees an input voltage of V1 that starts at the open circuit voltage of the modules 16; and a corresponding controller (not shown) then regulates it to maximum power point voltage by drawing power from this section/stage 12 of the string. When this stage 12 reaches steady state, switch S2 is enabled, while leaving switch S1 turned ON, thus briefly short circuiting the second section/stage 18 of the string. Subsequent to this brief overlap 20 depicted more clearly in FIG. 2, switch S1 is turned OFF and the voltage across capacitor C starts building up, without having any sudden rise. Similarly, the last section/stage 19 of the string is switched in as depicted in FIG. 2 that shows a brief overlap 22 during which time switch S3 is enabled, while leaving switch S2 turned ON. This method of switching thus provides a smooth PV inverter 14 input voltage profile that also minimizes the number of capacitors 17 resulting in a more simplified structure. The overlap in timing shown in FIG. 2 advantageously provides smooth voltage changes. Any excessive voltage rise across the PV module string including stages 12, 18 and 19 that the controller cannot regulate, can be limited by switching sections of the string back out in sequence to limit the inverter input voltage. This embodiment of a sequential switching method requires switches S1, S2, S3 and any additional switches needed for more stages to allow bi-directional power flow.

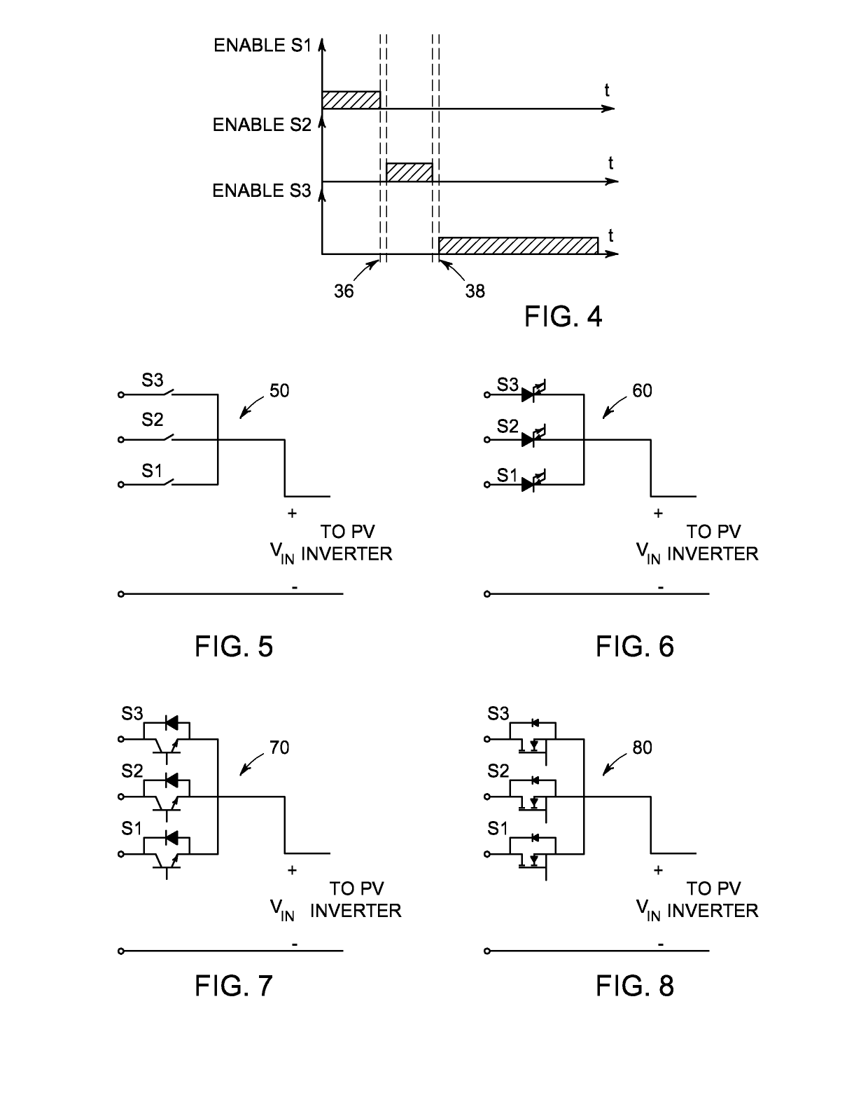

FIG. 3 illustrates a sequentially switched PV string 30 according to another embodiment. Sequentially switched PV string 30 comprises a switched capacitor bank 32 and advantageously does not require bi-directional current flow in the switches 34. Similar to the embodiments described with reference to FIGS. 1 and 2, each section of the PV string 30 is sequentially connected to the PV inverter 14 such that the operating open circuit voltage (V1) is in the safe operating area of the inverter switches 34. When power starts being drawn from the first section/stage 12 of the string, the voltage gradually decreases, and can be regulated by the controller (not shown) to settle at the maximum power point for this section 12. After this stage 12 reaches its steady state, a second section/stage 18 of the PV string 30 is switched in, and the voltage input to the inverter 14 is (V1+V2), where, only V2 represents an open circuit voltage. Voltage control of the two sections 12, 18 of the string is performed in a similar way as for the first section. Finally, the last section/stage 19 of the PV string 30 is switched in after stage 18 reaches steady state and the input voltage becomes (V1+V2+V3) where only V3 is at an open circuit voltage level. A brief dead-time 36, 38 such as illustrated in FIG. 4 is most preferred during sequential switching from one stage to the next.

During the gradual switching of sections/stages 12, 18, 19 of the PV string 30 described above, the voltage input to the inverter 14 exhibits sudden rises and then a gradual reduction to the maximum power point voltage. The switching sequence from one stage to the next preferably includes a very short dead-time 36, 38 as stated herein to avoid short circuiting the capacitors C₁, C₂ and C₃, and generating high current spikes.

The switches 51, S2, S3 depicted in FIG. 1 and the 3-way switch 34 such as shown in FIG. 3 can either be electro-mechanical or electronic switches or a combination thereof. FIG. 5 illustrates an electro-mechanical switching structure 50 suitable for sequentially switching the PV strings depicted in FIGS. 1 and 3 according to one embodiment. The input switches 50 can be electro-mechanical switches such as contactors or even MEMS devices if a small number of strings are used. Semiconductor switches can also be used such as gate turn-off thyristor(s) GTOs 60 depicted in FIG. 6, IGBTs 70 depicted in FIG. 7 or MOSFETs (which can be S1 or SiC or any WBG devices) 80 depicted in FIG. 8. The embodiments described herein do not however really require fast switching. Other than the GTO 60 option, the other switch configurations 50, 70, 80 can also provide bidirectional current flow.

It is noteworthy that the last switch (S3 in FIG. 1) in some embodiments may be required to handle the full current of the string/strings/array it is connected to; hence, it should be a very low impedance switch (e.g. a contactor). Therefore, the set of switches may be a mix between semiconductor and electro-mechanical switches as stated herein.

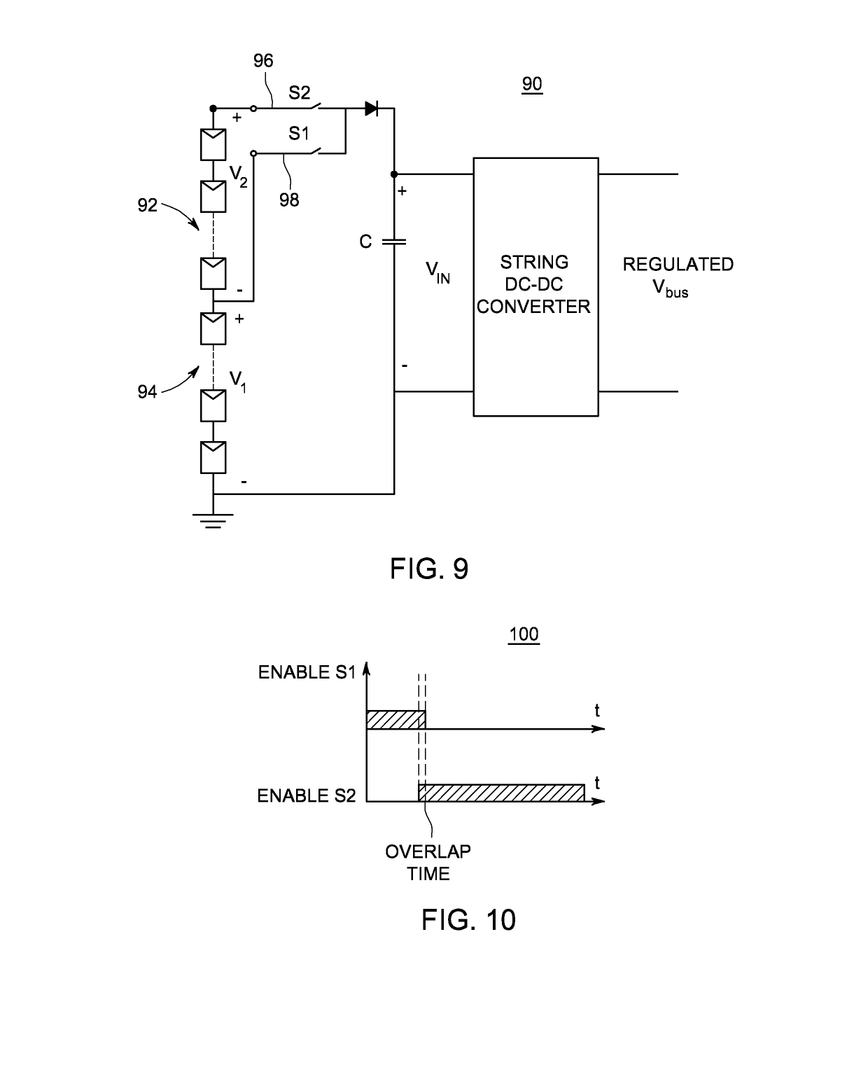

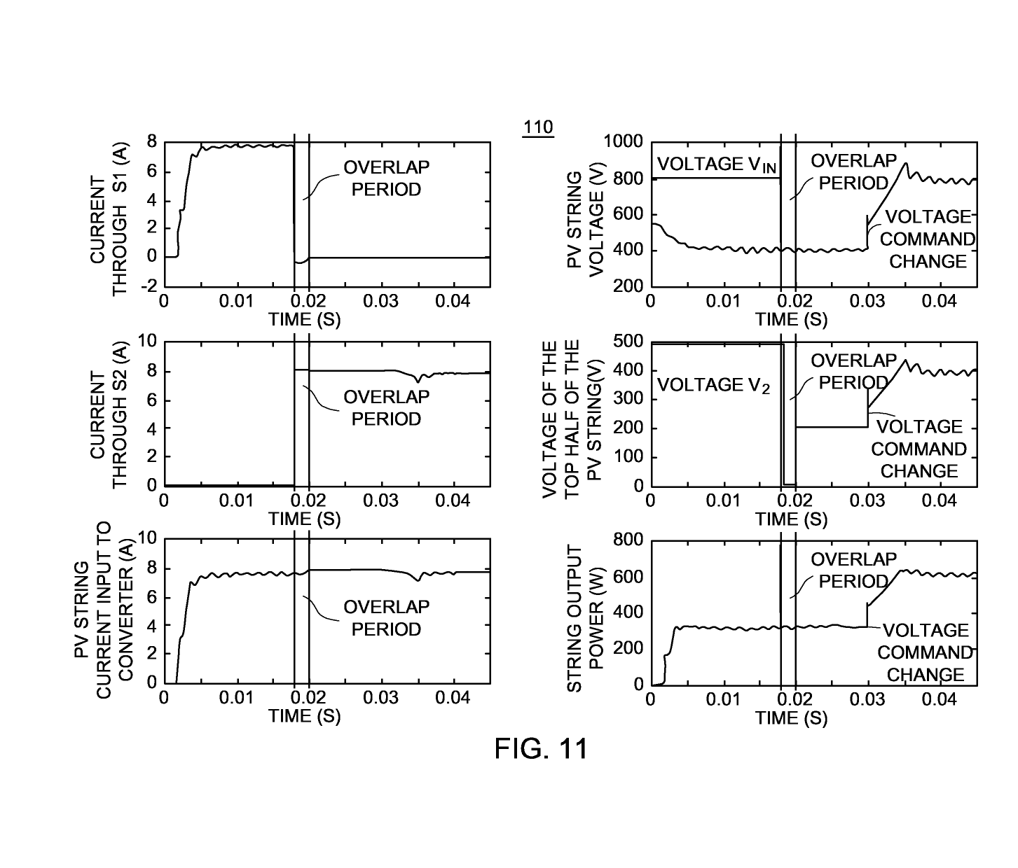

FIG. 9 illustrates a simulated sequentially switched PV string 90 according to one embodiment. The simulated sequentially switched PV string 90 comprises two string sections/stages 92, 94 adding up to 30 mc-Si modules having a rated open circuit voltage of ˜1000V (˜500V on each half) open circuit voltage and cold temperature voltage of 1200V total.

A method of operating the simulated sequentially switched PV string 90 according to one embodiment assumes the dc-bus voltage is regulated at 600V and the PV string section voltage reference is set to be 400V.

After reaching steady state (at time t=18 ms) the switch 96 of the top section 92 is turned ON overlapping with the lower switch 98 for 2 ms. At t=20 ms, the lower switch 98 is turned OFF and the full string 92, 94 is thus switched in while the reference voltage of the string is left at 400V.

FIG. 10 is a graph 110 illustrating relative switch timing for the switches 96, 98 depicted in FIG. 9 according to one embodiment. Finally at t=30 ms, the dc-bus voltage is raised to 900V and the string reference voltage is raised to 780V to bring the whole string to its MPP voltage. A set of graphs 110 illustrate the current and voltage waveforms of the simulated sequentially switched PV string 90.

In summary explanation, a startup procedure/method that enables a PV inverter to be connected to a string of series connected PV modules without exposing the inverter to elevated voltage stresses, according to one embodiment, comprises:

1. connecting the inverter to a power grid and charging the corresponding dc-link voltage to a low value to establish grid currents;

2. switching in a first section of the PV string having an open circuit voltage designed to be close to the startup dc-link voltage, to connect the first section of the PV string to the inverter;

3. subsequent to switching in the first section of the PV string, regulating the voltage of the connected PV string to the maximum power point;

4. switching in a second section of the PV string, connecting the inverter to the second section of the PV string, allowing a brief overlap time between switching events; and

5. subsequent to switching in the second section of the PV string, gradually increasing the dc-link voltage and regulating the voltage of the connected PV string to the maximum power point.

The embodiments described herein are applicable to the startup of both centralized and distributed PV plant architectures; and for distributed architectures, the embodiments described herein are applicable to plants using string inverters as well as those in which string level, string combiner level, or array combiner level dc-dc converters are used.

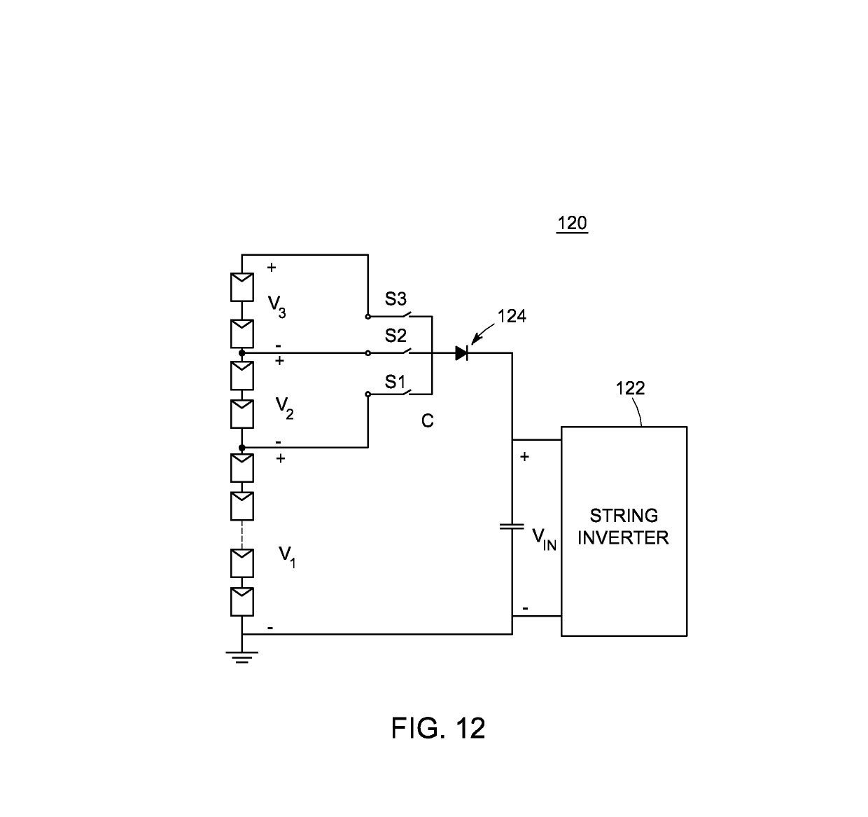

FIG. 12 illustrates a sequentially switched PV string 120 using string inverters 122 according to one embodiment.

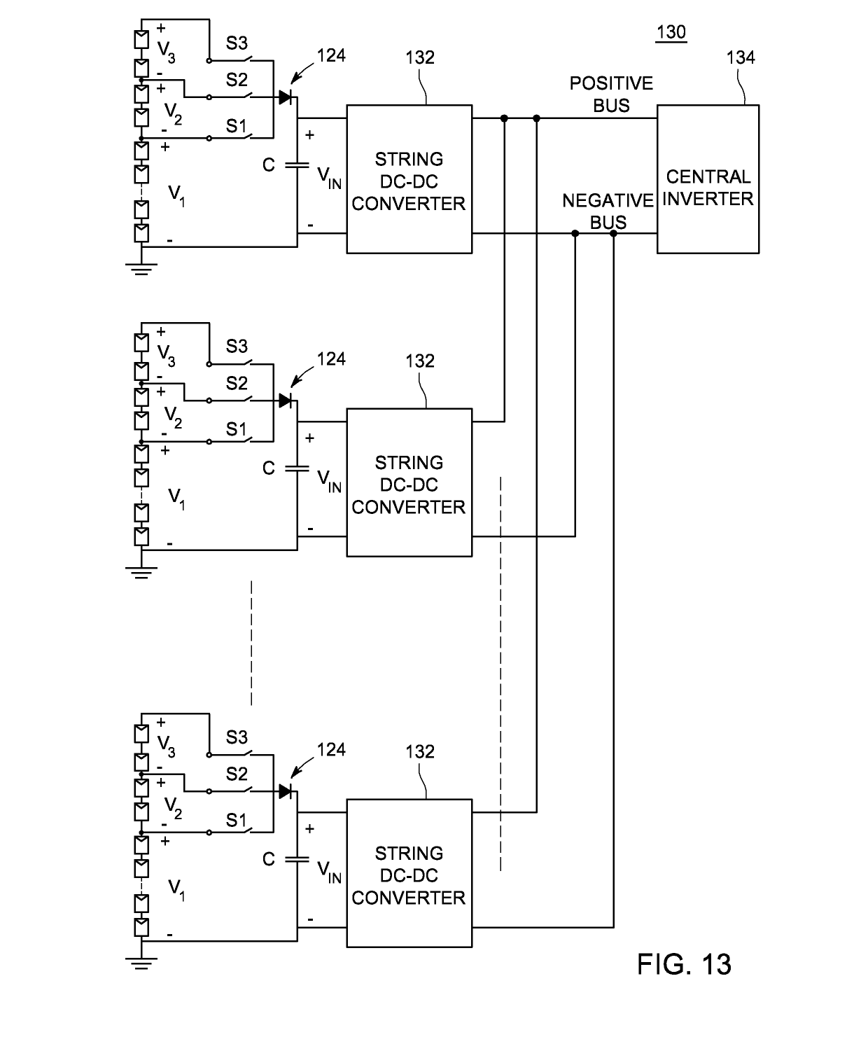

FIG. 13 illustrates a sequentially switched PV string 130 using string level dc-dc converters 132 with a central inverter 134 according to one embodiment.

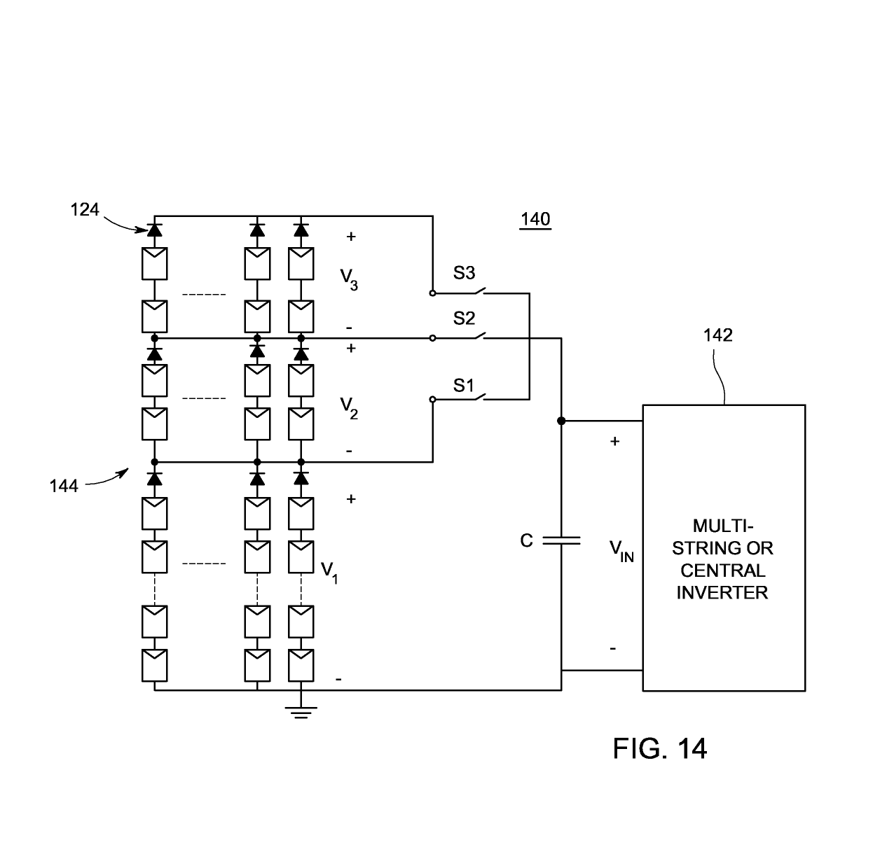

FIG. 14 illustrates a sequentially switched PV string 140 using a multi-string or central inverter 142 according to one embodiment.

With reference to FIGS. 12 and 13, an inverter or dc-dc converter connected to a single string only requires the addition of extra switching elements S1-S3; and if a blocking diode 124 is needed, it can be connected at the output of switching elements S1-S3 as illustrated. With reference to FIG. 14, multiple strings connected to the same inverter/converter 142 or in the case of central inverter, the PV strings 144 are connected in a series parallel architecture. This architecture, although slightly more complicated, is advantageously less sensitive to module mismatches. Further, if blocking diodes 124 are needed, then a diode needs to be placed in each section of each string to avoid having undesired current circulations in case of faulty string sections. The number of sections in which a PV module string is divided depends on the inverter rating, ac voltage level to be connected to on the grid side, and can also be traded off against the cost of installation.

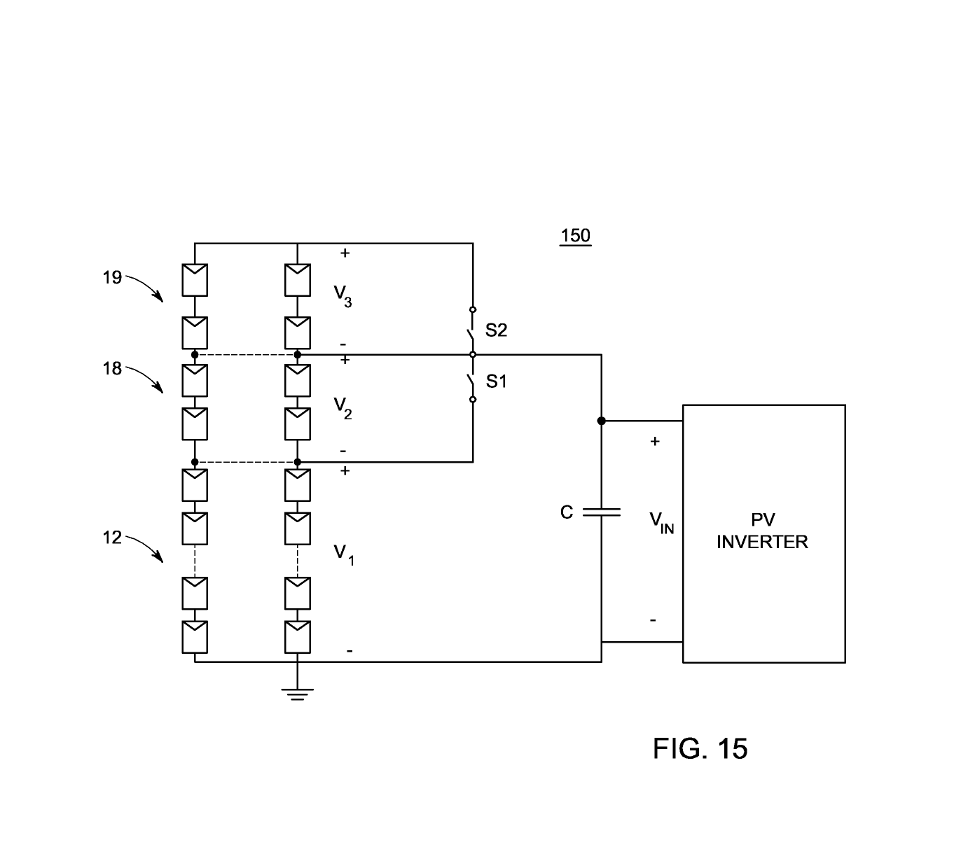

FIG. 15 shows another embodiment 150 for the sequential switching of the modules in the PV strings 12, 18, 19 that requires fewer switches. Only two switches, S1 and S2 are required to perform the same task as the three switch configuration depicted in FIG. 1. Operation in this embodiment starts with both switches S1 and S2 closed, thus shorting the upper sections 18, 19 of the PV string(s) 12, 18, 19. After the lower section 12 of the string(s) 12, 18, 19 starts supplying power to the grid and the voltage of this section is regulated to the maximum power point voltage, switch S1 is then opened thus connecting the second section 18 of the string in series with the first one. Similarly, when the voltage of these two sections 12, 18 is regulated to the target value, the second switch, S2, is opened and the third section 19 is switched into the circuit. During conditions where power from the PV array needs to be limited, the switches can be used to short circuit the unwanted sections of the PV string(s) 18, 19. Similar to other embodiments described herein, this architecture 150 is also expandable to include more sections; but it has the advantage that it requires one less switch compared to the structure illustrated in FIG. 1.

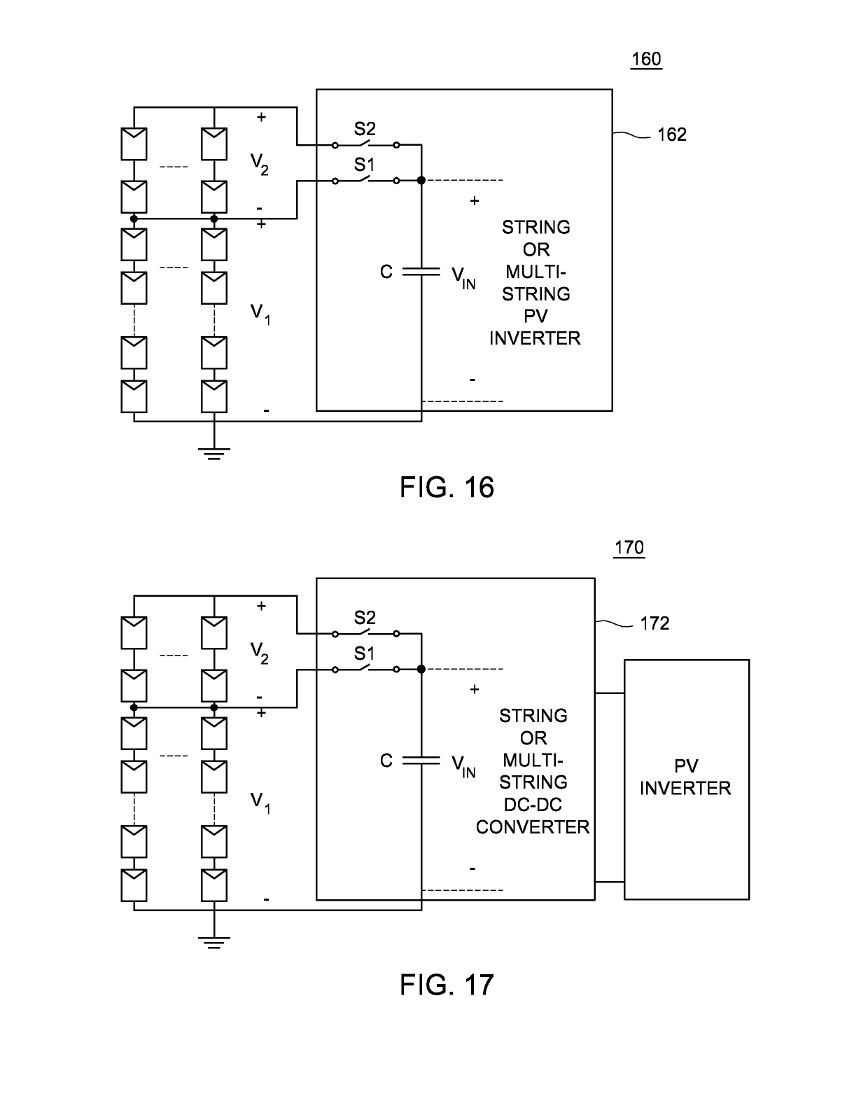

Since the control switches can be semi-conductor switches, the control switches can be integrated within the power converter stage rather than being implemented as external switching units such as shown in FIG. 15. FIG. 16, for example depicts the control switches S1, S2 integrated within a string or multi-string PV inverter 162, while FIG. 17 depicts the control switches S1, S2 integrated within a string or multi-string dc-dc converter 172.

This embodied switching methods can also be used to limit/control power flow from a PV array by reducing the number of connected modules either by short circuiting them as with the configuration in the embodiment depicted in FIG. 1 or open circuiting sections of the string using the setup depicted in FIG. 2. This feature can also be useful in maintaining control stability during voltage sags and/or low voltage ride through conditions.

While the invention has been described in terms of various specific embodiments, those skilled in the art will recognize that the invention can be practiced with modification within the spirit and scope of the claims.

What is claimed is:

1. An apparatus comprising:
a plurality of photovoltaic (PV) module stages, each PV module stage comprising an output, each PV module stage comprising a plurality of PV modules connected together in series, the plurality of PV module stages connected together to form at least one string of series connected PV module stages;
a sequentially operating switching mechanism; and
an inverter stage comprising an input, wherein the switching mechanism sequentially couples a plurality of PV module stage outputs to the inverter stage input.

2. The apparatus according to claim 1, further comprising one or more capacitors connected directly to the inverter stage input.

3. The apparatus according to claim 1, wherein each PV module stage further comprises one or more corresponding capacitors connected directly to its output, and further wherein the switching mechanism sequentially couples a plurality of PV module output capacitors to the inverter stage in synchronization with corresponding PV module stages.

4. The apparatus according to claim 1, wherein the inverter stage comprises:
a PV string level dc-dc converter; and
a central inverter driven in response to the string level dc-dc converter.

5. The apparatus according to claim 1, wherein the inverter stage comprises a multi-string PV inverter.

6. The apparatus according to claim 1, wherein the inverter stage comprises a PV string inverter.

7. The apparatus according to claim 1, wherein the switching mechanism comprises one or more electro-mechanical switches.

8. The apparatus according to claim 1, wherein the switching mechanism comprises one or more electronic switches selected from gate turn-off thyristor switches, insulated gate bipolar transistor switches, MOSFET switches, and micro-electro mechanical switches.

9. The apparatus according to claim 1, wherein the switching mechanism comprises a three-way switch.

10. The apparatus according to claim 1, wherein the switching mechanism comprises a plurality of parallel connected switches.

11. The apparatus according to claim 10, wherein the plurality of switches comprise electronic switches, electro-mechanical switches, or a combination thereof.

12. The apparatus according to claim 1, wherein the strings of PV module stages are connected together in parallel when the plurality of PV module stages connected together form more than one string of series connected PV module stages.

13. The apparatus according to claim 1, wherein the switching mechanism is integrated within the inverter stage or a corresponding dc-dc converter stage.

14. A method of connecting photovoltaic (PV) modules to an inverter, the method comprising:
providing a plurality of photovoltaic (PV) module stages, each PV module stage comprising a plurality of PV modules connected together in series, the plurality of PV module stages connected together to form at least one string of series connected PV module stages;
connecting an inverter to a power grid and charging a corresponding dc-link voltage to a predetermined value to establish a power grid current;
connecting one or more first PV module stages selected from the plurality of PV module stages directly to the inverter and regulating the output voltage of the directly connected first PV module stages to a maximum power point level;
connecting one or more additional PV module stages selected from the plurality of PV module stages directly to the inverter while the first PV module stages are directly connected to the inverter;
removing the direct connection of the first PV module stages to the inverter subsequent to connecting the one or more additional PV module stages to the inverter, such that both the first PV module stages and the one or more additional PV module stages are connected in series to the inverter via the one or more additional PV module stages, and regulating the combined output voltage of the connected first PV module stages and the one or more additional PV module stages to the maximum power point level.

15. The method according to claim 14, further comprising short circuiting one or more selected sections of at least one PV string to regulate power flow, improve control stability during transient or fault conditions, or both regulate power flow and improve control stability during transient or fault conditions.

16. A method of connecting photovoltaic (PV) modules to an inverter, the method comprising:
providing a plurality of photovoltaic (PV) module stages, each PV module stage comprising a plurality of PV modules connected together in series, the plurality of PV module stages connected together to form at least one string of series connected PV module stages;
connecting an inverter to a power grid and charging a corresponding dc-link voltage to a predetermined value to establish a power grid current;
connecting one or more first PV module stages selected from the plurality of PV module stages directly to the inverter and regulating the output voltage of the directly connected first PV module stages to a maximum power point level;
disconnecting the one or more first PV module stages from the inverter;
connecting one or more additional PV module stages selected from the plurality of PV module stages directly to the inverter subsequent to disconnecting the one or more first PV module stages from the inverter such that both the one or more first PV module stages and the one or more additional PV module stages are connected in series to the inverter via the one or more additional PV module stages, and regulating the combined output voltage of the connected one or more first PV module stages and the one or more additional PV module stages to the maximum power point level.

17. The method according to claim 16, further comprising switching out one or more selected sections of at least one PV string to regulate power flow, improve control stability during transient or fault conditions, or both regulate power flow and improve control stability during transient or fault conditions.

18. A method of connecting photovoltaic (PV) modules to an inverter or dc-dc converter, the method comprising:
providing a plurality of photovoltaic (PV) module stages, each PV module stage comprising a plurality of PV modules connected together in series, the plurality of PV module stages connected together to form at least one string of series connected PV module stages;
connecting an inverter or dc-dc converter to a power grid and charging a corresponding dc-link voltage to a predetermined value to establish a power grid current;
short circuiting the output of all but one PV module stage within a string of series connected module stages such that only the output of the single PV module stage without a shorted output is connected directly to the inverter or dc-dc converter and regulating the output voltage of the directly connected PV module stage to a maximum power point level;
removing in succession, the short circuit across the output of each PV module stage within the string of series connected module stages having a short circuited output; and
connecting in succession, the outputs of the PV module stages without shorted outputs together in series as the PV module stages without shorted outputs become available;
connecting to the inverter or dc-dc converter in succession, the output of the series connected PV module stages without shorted outputs as they become available; and
regulating in succession, the combined output voltage of the series connected PV module stages without shorted outputs to the maximum power point level as they become available.
